(19) United States
(12) Patent Application Publication
(10) Pub. No.: US 2011/0221898 A1
(43) Pub. Date: Sep. 15, 2011

(54) CAPTURE AND PLAYBACK OF COMPUTER SCREEN CONTENTS AND ACCOMPANYING AUDIO

(75) Inventor: John Williiam Leis, Toowoomba Queensland (AU)

(73) Assignee: THE UNIVERSITY OF SOUTHERN QUEENSLAND, TOOWOOMBA QUEENSLAND (AU)

(21) Appl. No.: 13/060,269

(22) PCT Filed: Aug. 21, 2009
(86) PCT No.: PCT/AU09/01077

§ 371 Date: May 10, 2011

(30) Foreign Application Priority Data
Aug. 21, 2008 (AU) 2008904295

(51) Int. Cl. H04N 7/18

(52) U.S. Cl. 348/143; 348/E07.085

(57) ABSTRACT

Computer screen contents and accompanying audio are captured by a method, embodiments of which are implemented by a specialized apparatus. Embodiments of the method include capturing an image of the computer screen contents at predetermined time intervals and determining one or more changes between a current captured image and a previous captured image. The method also includes modifying color data associated with a changed region of the current captured image and encoding the modified color data for the changed region.

### FIELD OF THE INVENTION

The present invention relates generally to systems, methods & apparatus for capturing and playing back computer screen contents and/or accompanying audio. In particular, but not exclusively, embodiments of the present invention relate to capturing computer screen contents and/or accompanying audio generated by computer applications for and relating to presentations, lectures and the like.

### BACKGROUND TO THE INVENTION

It is often desirable to record the contents of a computer screen for immediate playback, for example at a remote location, or for playback at a later time. For example, a range of known computer applications are often used to give a lecture, seminar or other presentation and students and/or a presenter may wish to review a lecture, seminar or other presentation at some time after the lecture etc. was given for study or assessment purposes. Alternatively, distance-learning students, for example, located remotely from a lecture venue may wish to view the lecture etc. in substantially real time. Lectures, seminars and the like typically include the use of power point presentations, spreadsheets, graphics and/or web browsers.

Another requirement is the recording and playback of audio that accompanies a lecture, seminar or other presentation. Various systems, methods and apparatus are available that record and playback the audio either substantially simultaneously or at a later time, for example, over communications networks, such as the Internet. The listener has conventional control over the audio with features such as stop, play, fast forward, rewind and pause. However, such systems, methods and apparatus typically do not include the accompanying computer screen output and therefore are of limited value. Such systems, methods and apparatus are typically used for distance learning wherein the students listen to the audio for a lecture at some time after the lecture was given. The computer screen output, such as a power point presentation, is provided in static format, such as a series of screen shots or slides, by another means, for example, via email, for the student to review whilst listening to the audio.

A number of different systems, methods and apparatus relating to computer screen motion capture and the like are disclosed in the following patents and patent applications: WO 2004/053797, U.S. Pat. No. 5,816,820, U.S. Pat. No. 6,370,574 GB 2359469, U.S. Pat. No. 6,539,418 and in Lui T-Y et al., “A Novel Algorithm for Real-Time Full Screen Capture System”, Proc. IEEE 5^{th} Workshop on Multimedia Signal Processing, pp. 396-400, October 2001.

WO2004/053797 discloses an algorithm that splits the screen into fixed-size column blocks, such as 80 pixels wide, and determines change regions within each block. There can be multiple small change regions within each block, which are encoded separately. Although WO2004/053797 refers to the problem of synchronising audio with the captured screen output, no solution is provided.

U.S. Pat. No. 5,816,820 describes an approach which captures the screen output based on input from a user input device. After any input, the screen is checked for changes. However, such an approach cannot detect unprompted screen changes, which might occur in slide builds, for example. Furthermore, such an approach requires access to operating system hooks, which is problematic because it may be interpreted as malicious software by the operating system or virus scanners.

U.S. Pat. No. 6,370,574 describes simultaneous computer screen and voice monitoring from a remote location using synchronized telephone and screen monitoring. The audio monitoring described in this patent pertains to conventional telephone conversations rather than audio as sampled through a computer. In one embodiment, graphics primitives are used to determine localized screen changes and in another embodiment, localized screen changes are determined by full screen comparison. The former is essentially similar to U.S. Pat. No. 5,816,820 discussed above.

GB 2359469 describes identifying one or more windows and encoding a description of the first set of windows indicative of the appearance of the computer screen in a first frame. A second frame is identified including one or more windows corresponding respectively to one or more in the first set of windows and subsequently determining one or more transformations applied to the first frame window to generate the second frame. This method relies on the appearance and characteristics of the windows and the determination of transformations of windows from one frame to the next.

U.S. Pat. No. 6,539,418 is directed to remotely controlling a computer, which is distinct from the storage of screen contents, but discloses analysing screen information in order to reduce the required bandwidth, which is a useful principle in relation to capturing screen contents. Although U.S. Pat. No. 6,539,418 is focussed on the control aspect, the transmission of the screen contents is described and various possibilities are disclosed including utilizing 5 bits per colour plane for a total of 15 bits per pixel.

Lui T-Y et al. describes real-time screen capture for tutorials or the like streamed over an intranet or the Internet. The method involves a compression algorithm that utilises a histogram (probability) based approach in which more common colours are assigned a shorter binary codeword. The system only captures differences of successive snapshots rather than every single screen and can capture 30 frames per second at a resolution of 1600×1200. However, this system incurs additional processing overhead that is undesirable in many applications.

In this specification, the terms “comprises”, “comprising”, “includes”, “including” or similar terms are intended to mean a non-exclusive inclusion, such that a method, system or apparatus that comprises a list of elements does not include those elements solely, but may well include other elements not listed.

### OBJECT OF THE INVENTION

It is an object of the present invention to provide a system and/or a method and/or an apparatus that addresses or at least ameliorates one or more of the aforementioned problems of the prior art or provides consumers with a useful commercial alternative.

### SUMMARY OF THE INVENTION

Embodiments of the present invention provide a method and apparatus for capturing and playing back computer screen contents, such as images and text and/or accompanying audio and/or accompanying movements of pointers and the like. In preferred embodiments, the computer screen contents are synchronized with the audio and/or the accompanying movements of cursors and the like.

According to one aspect, although not necessarily the broadest or only aspect, embodiments of the present invention reside in a method of capturing computer screen contents including:

capturing an image of the computer screen contents at predetermined time intervals;

determining one or more changes between a current captured image and a previous captured image;

modifying colour data associated with a changed region of the current captured image; and

encoding the modified colour data for the changed region.

Suitably, the method includes delaying further processing if the one or more changes between the current and previous captured images are greater than a predetermined threshold, such as a threshold percentage of the area of the screen or a threshold number of pixels.

Preferably, the method includes determining a frame containing pixels comprising the changed region.

Preferably, modifying colour data associated with the changed region includes reducing the colour space for each pixel.

Preferably, encoding the modified colour data includes using runlength encoding.

The method may further include compressing the changed region using JPEG image compression or fractal compression.

Suitably, the method includes sampling accompanying audio at the predetermined time intervals.

Suitably, the method includes determining an energy level of each audio sample to determine whether the sample contains audible content.

Suitably, the method includes compressing the audio samples comprising audible content and encoding the compressed audio samples.

Suitably, the method includes determining a position of a cursor on the computer screen at the predetermined time intervals.

Preferably, the method includes synchronizing computer screen images with an accompanying block of audio samples and/or with the accompanying position of the cursor.

According to another aspect, although again not necessarily the broadest aspect, embodiments of the present invention reside in an apparatus for capturing computer screen contents comprising:

a memory for storing images of the computer screen contents captured at predetermined time intervals; and

a processor operatively coupled to the memory for:
determining one or more changes between a current captured image and a previous captured image;
modifying colour data associated with a changed region of the current captured image; and
encoding the modified colour data for the changed region.

According to a further aspect, although again not necessarily the broadest aspect, embodiments of the present invention reside in an apparatus for capturing computer screen contents comprising:

computer readable program code components executed to cause capturing an image of the computer screen contents at predetermined time intervals;

computer readable program code components executed to cause determining one or more changes between a current captured image and a previous captured image;

computer readable program code components executed to cause modifying colour data associated with a changed region of the current captured image; and

computer readable program code components executed to cause encoding the modified colour data for the changed region.

According to yet anther aspect, although again not necessarily the broadest aspect, embodiments of the present invention reside in a machine readable medium having recorded thereon a program of instructions for causing a machine to perform a method of capturing computer screen contents, the method including:

capturing an image of the computer screen contents at predetermined time intervals;

determining one or more changes between a current captured image and a previous captured image;

modifying colour data associated with a changed region of the current captured image; and

encoding the modified colour data for the changed region.

Further features and aspects of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is a schematic representation of an apparatus according to embodiments of the present invention;

FIG. 2 is a general flow diagram illustrating a method according to embodiments of the present invention;

FIG. 3 is a general flow diagram illustrating a method of audio capture according to embodiments of the present invention; and

FIGS. 4-6 are screenshots illustrating methods according to embodiments of the present invention.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

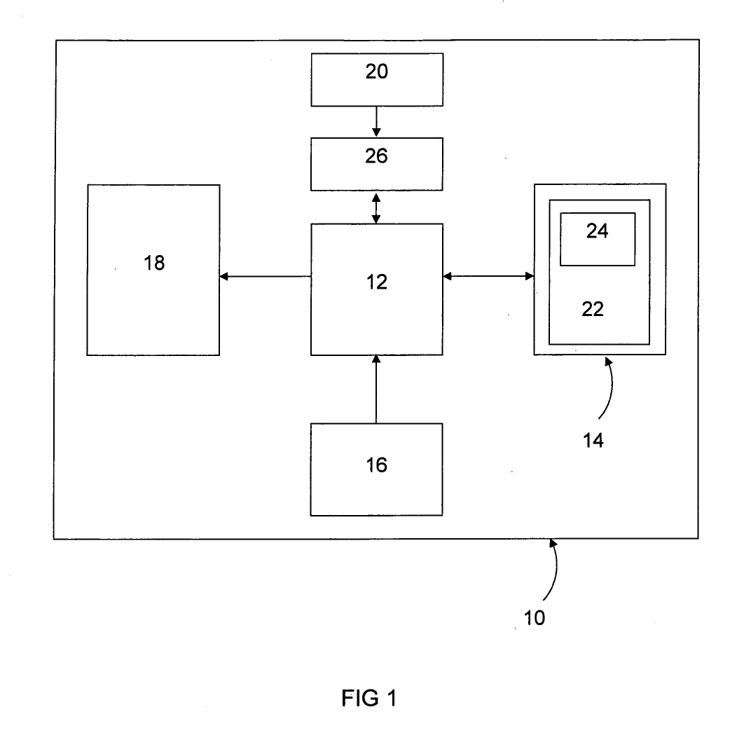

With reference to FIG. 1, an apparatus or machine 10 for capturing computer screen contents and optionally accompanying audio and optionally accompanying positions of a cursor and the like is provided in accordance with embodiments of the present invention. Apparatus 10 comprises a processor 12 operatively coupled to a storage medium in the form of a memory 14. An input device 16, such as a keyboard, mouse and/or pointer, is operatively coupled to the processor 12 and an output device 18, such as a computer screen, is operatively coupled to the processor 12. A microphone 20 is operatively coupled to the processor 12 via an auxiliary audio processor 26. The aforementioned arrangement for apparatus 10 can be a typical computing device and accompanying peripherals as will be familiar to one skilled in the art. It will be appreciated that in some embodiments the input device 16 and the output device 18 can be combined, for example, in the form of a touch screen.

Memory 14 comprises a computer or machine readable medium 22, such as a read only memory (e.g., programmable read only memory (PROM), or electrically erasable programmable read only memory (EEPROM)), a random access memory (e.g. static random access memory (SRAM), or synchronous dynamic random access memory (SDRAM)), or hybrid memory (e.g., FLASH), or other types of memory as is well known in the art. The computer readable medium 22 comprises computer readable program code components 24 for capturing computer screen contents and optionally accompanying audio and optionally accompanying positions of a cursor and the like in accordance with the teachings of the present invention, at least some of which are selectively executed by the processor 12 and are configured to cause the execution of the embodiments of the present invention described herein. Hence, the machine readable medium 22 has recorded thereon a program of instructions for causing the machine 10 to perform the method of capturing computer screen contents and optionally accompanying audio and optionally accompanying positions of a cursor and the like in accordance with embodiments of the present invention described herein.

Considering the issue of capturing computer screen content together with audio and cursor movements, a typical screen resolution is of the order of 1200×1000 pixels. Therefore, for a one hour presentation, capturing the screen contents at a rate of two captures per second would consume of the order of 1200×1000×3×60×60×2 bytes, or approximately 25 GB. If the audio is captured at a sampling rate of 8 kHz, at 16 bits per sample, this would require 8000×2×60×60 bytes, or approximately an additional 60 MB.

Embodiments of the present invention rely on the observation that only changes in the screen content are required to build up successive screen images rather than a whole new image of the entire screen content for each capture. Embodiments of the present invention comprise further refinements to this basic principle as described below. According to some embodiments, accompanying audio information is also compressed using a nonlinear sound amplitude compressor and efficiently encoding portions of silence within the audio. Embodiments of the present invention are able to compress both audio and video information into a significantly smaller memory space than the prior art, typically of the order of 10-20 MB per hour.

All of the above occurs in real-time in that the data is captured and compressed to memory, such as a disk file whilst recording takes place. This simplifies the operation from the user's perspective in that a post-processing stage is not required by the end user performing the recording. As a side-effect, this approach also enhances the reliability of the recording function. Should the computer crash due to power failure or other unforseen circumstance, the recording should remain intact.

Both the audio and image processing use a technique known as double-buffering. The block of data samples that is being encoded or decoded is separate to the audio which is being played back or the image which is being displayed. This is done to avoid audible gaps in the audio stream and avoid any flickers when the screen is updated. Embodiments of the present invention capture an image frame when each audio buffer has been sampled, that is input from the microphone 20, which occurs twice every second. However, other capture rates can be used, such as, but not limited to four times every second or one capture every 0.25 seconds.

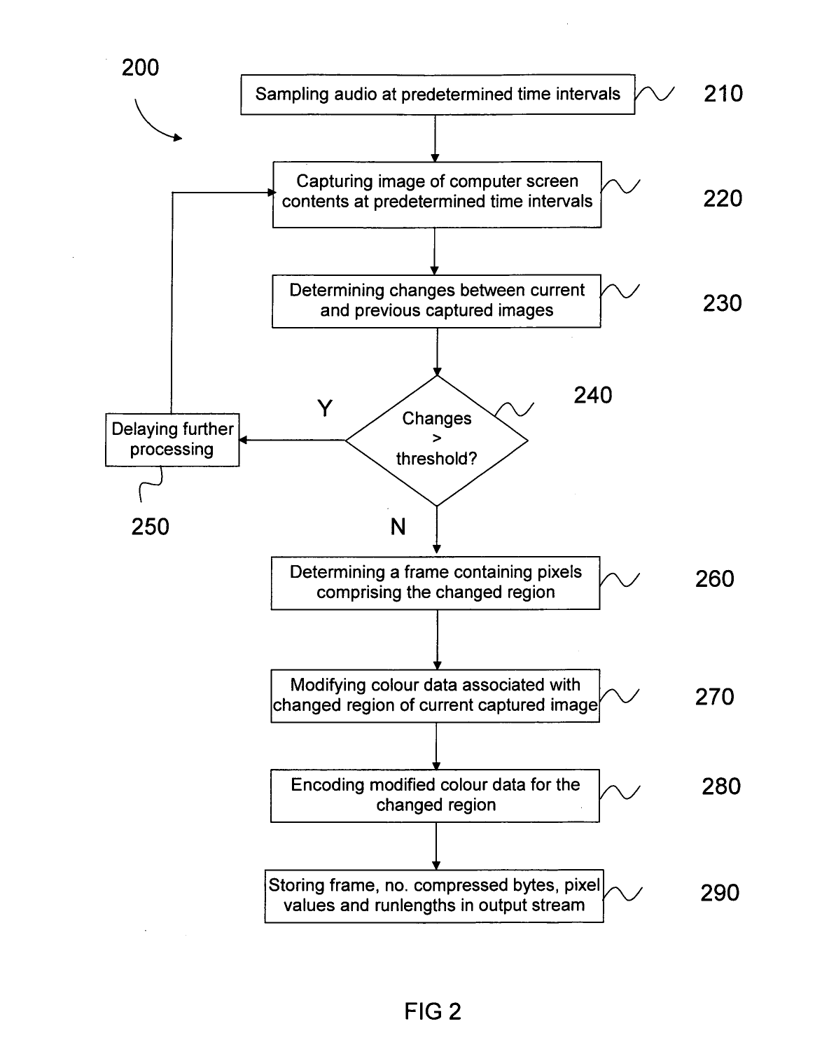

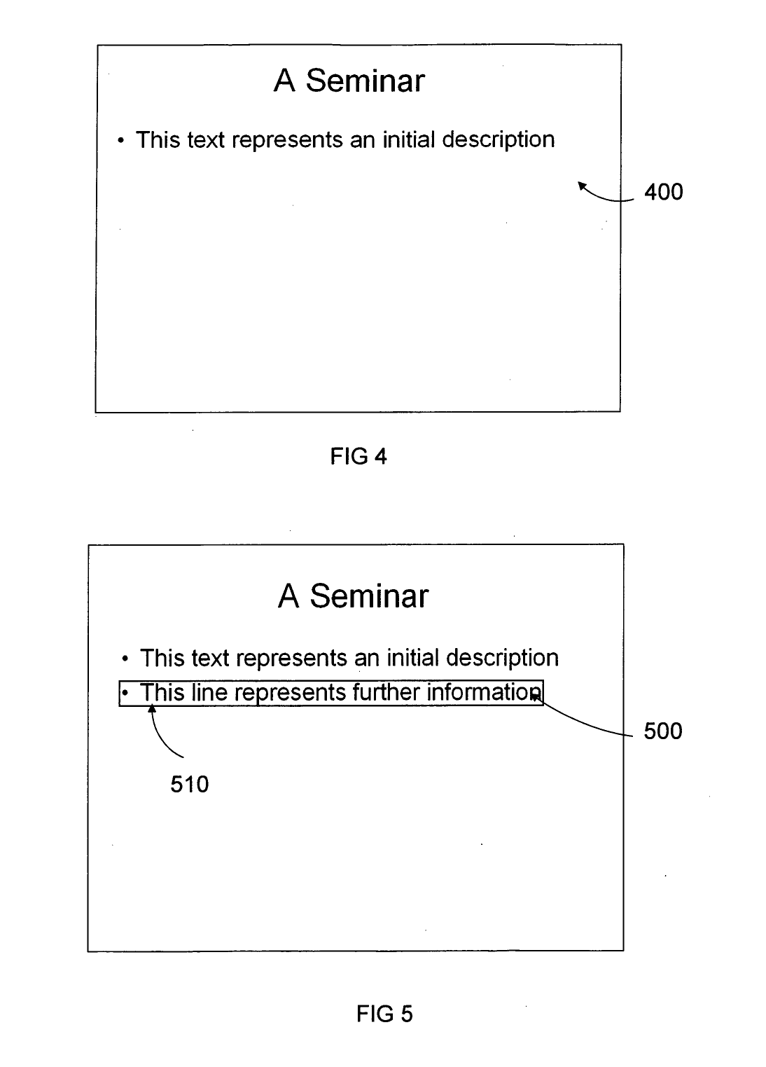

With reference to the general flow diagram shown in FIG. 2 and the screenshots in FIGS. 4-6, the method 200 of capturing computer screen contents includes at 220 capturing an image of the computer screen contents 400 at predetermined time intervals. The computer screen contents captured in each time interval is stored in the memory 14 with three bytes for each pixel representing the amount of red, green and blue comprising each pixel.

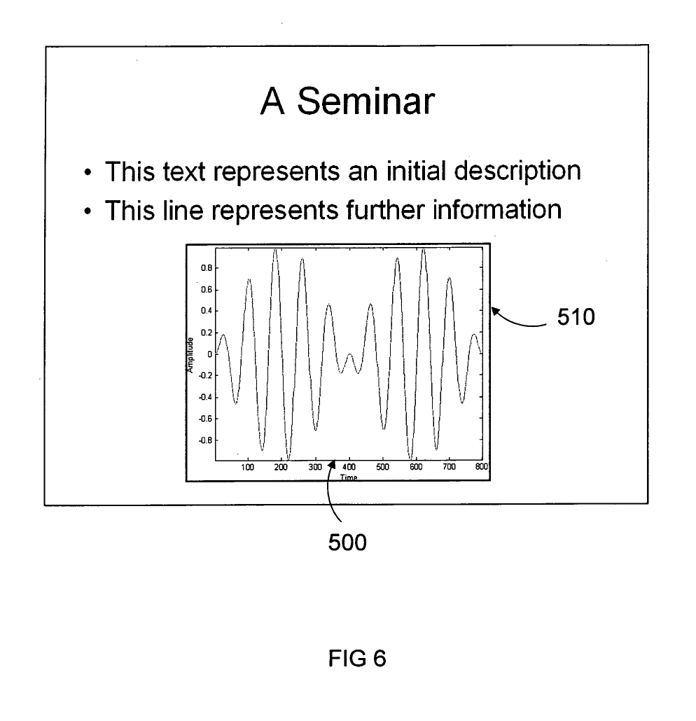

The method includes at 230 determining one or more changes between a current captured image and a previous captured image. This includes comparing every pixel in the current captured image to corresponding pixels of the previous captured image stored for the previous time interval. If there is any change in any pixels at all, a flag is set in the memory 14 to indicate that the computer screen contents have changed and an update is warranted. FIG. 4 shows a previously captured image of computer screen contents 400 in the form of some text for a seminar. FIG. 5 shows a current image of the computer screen contents 400 captured after a predetermined time interval during which time there has been a change. In FIG. 5, the computer screen contents 400 comprise a changed region 500 that includes some additional text. In FIG. 6, the computer screen contents 400 comprise a changed region 500 that includes an image in the form of a graph.

At 240, the method includes determining whether the changes between the current and previous captured images are greater than a predetermined threshold. According to some embodiments, the predetermined threshold is based on a screen area. If the area of the changed region 500 is less than the predetermined threshold, the change in the image is deemed to be a “small change” and the image is processed further as described below. If the area of the changed region 500 is greater than the predetermined threshold, the change in the image is deemed to be a “large change” and the method includes at 250 delaying further processing. According to some embodiments, the predetermined threshold is set at 80% of the screen area, i.e. if less than 80% of the screen area has changed between a captured image and a previous captured image, the change is considered “small” and processing continues. However, it will be appreciated that the present invention is not limited to this specific predetermined threshold value and that other values greater or less than this value can be used. According to some embodiments, the predetermined threshold value can be in the range of about 60-90%.

According to other embodiments, the predetermined threshold is based on the number of pixels that have changed rather than the screen area and the predetermined threshold value can be in the range of about 60-90%. In these embodiments, if the predetermined threshold value is set at, for example, 70%, if the number of pixels that have changed between the current and previous captured images is greater than the predetermined threshold, the change in the image is deemed to be a “large change” and the method 200 includes at 250 delaying further processing. Conversely, if the number of changed pixels is less than 70%, the image is processed further as described below.

The aforementioned thresholding in relation to the changed region 500 decreases the amount of data that need to be stored. For example, a user (presenter, lecturer etc.) may be in the process of rapidly moving between slides and therefore intermediate screen captures are not required that would take up significant, but unnecessary storage space.

If the change is deemed to be a “large change”, a poll timeout is set before an image of the computer screen is re-captured. According to some embodiments, the poll timeout is approximately 5 seconds, but other poll timeout periods can be used. This means in practice that any change of a large area will take 5 seconds to be processed for storage in the compressed file.

A second timer interval is used to check the change/no change flag indication. According to some embodiments, this timer interval is 0.5 seconds. If the flag is set, it indicates that the screen has changed and that further processing is required. The method 200 includes at 260 determining a frame or bounding box 510 of the screen containing the pixels comprising the changed region 500. The method includes determining the rows, columns, width and height of the frame or box 510 which can contain all of the changed pixels within the screen image.

If the area of the changed region 500 is less than the predetermined threshold, the method includes at 270 modifying colour data associated with the changed region of the current captured image. According to preferred embodiments, modifying the colour data associated with the changed region 500 includes pre-processing the image by reducing the colour space for each pixel. This is done by removing the 4 least-significant bits from each of the three 8-bit colour components, thus halving the amount of information. Experiments have shown that this reduction in colour space is generally not noticeable to the user.

The method 200 includes at 280 encoding the modified colour data for the changed region 500 and in preferred embodiments, encoding the modified colour data includes using runlength encoding. The rows, columns, width and height of the frame for the changed region comprising the colour reduced pixels are processed using a runlength encoder (RLE). Pixels are encoded either as specific 12-bit values, or a special escape indicator to indicate a pixel value followed by a repeat count (run length) is used. The escape indicator is not coded in the conventional sense of having a single-bit or other indicator. Rather, the escape indicator is encoded by reserving one of the 4096 possible colours to represent that a run of like-coloured pixels follows. This method efficiently encodes areas of window or screen background that are substantially the same colour, such as window title bars, etc. The method 200 includes at 290 storing the frame 510, the number of compressed bytes, the pixel values and the runlengths in the output stream.

The decoding process is essentially the reverse of the aforementioned encoding process. Individual pixels or runs of pixels are expanded into a temporary memory area equal to the size of the frame 510 for the changed region 500. This frame is then copied into the frame buffer which the decoder (player) maintains to update the screen image.

According to some embodiments, the method 200 includes at 210 sampling the accompanying audio at the predetermined time intervals. Where the audio accompanying the screen images is to be captured, the audio is captured by microphone 20 in blocks of samples for efficiency. For each audio block that is sampled, screen images are captured. Once each block of samples is ready for processing, a notification is sent from the auxiliary audio processor 26 to the primary operating system of the processor 12 and supplies another memory buffer for the subsequent audio buffer. The primary operating system acknowledges the auxiliary audio processor that the notification is received to enable it to begin collecting another buffer of sound samples. Whilst this occurs, the primary operating system takes control of the memory block of samples and proceeds to compress the sound data contained therein. This is done in order to avoid any gaps in the audio stream, which would be audible. With reference to step 230 above, where the accompanying audio is being captured, when a flag is set in the memory 14 to indicate that the computer screen contents have changed and an update is warranted, processing of the audio information has to be given the highest priority because any delays in audio processing may become audible to the user in the recording. Processing of the audio information is therefore prioritised and must be processed in real-time.

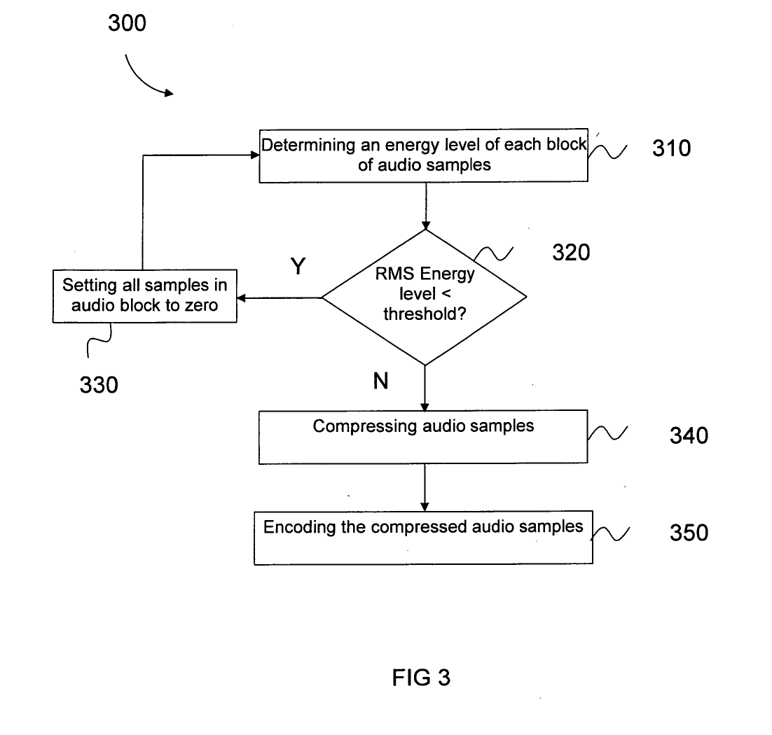

With reference to FIG. 3, the method 300 includes at 310 determining an energy level of each block of audio samples to determine whether the samples contain audible content or whether each audio sample is merely silence. This is done using a root-mean-square (RMS) calculation on the block of audio samples. A block of audio samples with less than a predetermined level or threshold of audio is deemed to be silence. Hence, the method includes at 320 determining whether the energy level of each audio block is less than a predetermined level or threshold. If so, the audio block is determined not to contain audible content and the method 300 includes at 330 setting all samples in such an audio block with a sample value of zero. If there is no audible content, the block does not need to be processed and the energy level of the next audio block is determined at 310.

The predetermined level or threshold of audio below which the samples are deemed to contain silence can be calculated in various ways. One method is to use the largest absolute value of samples in a memory buffer block. An alternative method is to use the RMS value as calculated by the square root of the average of the sum of the squares individual amplitudes. For consistent operation, the predetermined level or threshold of audio should be independent of the buffer size. For samples taken at 16 bit resolution, an RMS value of 200 gives acceptable results as found through experimentation. The notion of “acceptable” is necessarily a trade-off between clipping or removing portions of the speech or other audio that is important, thus clipping certain words, and the number of blocks of audio that are deemed to contain silence which do not require individual samples to be preserved. If the threshold is set higher, more blocks are declared as null resulting in a lower rate. However, this results in some portions of speech being incorrectly deemed as silence resulting in audible distortion. Conversely, a lower threshold preserves greater fidelity, but requires more sound frames to be individually coded and therefore unnecessarily increasing the data rate.

If the energy level of the audio block is equal to or greater than the predetermined level or threshold, the audio block is determined to contain audible content and the method 300 includes at 340 compressing the audio samples comprising the audible content using a logarithmic compression function. This uses a pre-computed lookup table (LUT) for each 16 bit sample. Although the amplitude compression is defined by a mathematical function, the processing has to be done on each sample and hence for speed of operation the values are calculated and stored in a table for rapid access. The lookup table logarithmically compresses the audio amplitude on the 16 bit range to an 8-bit index. Thus, only half of the data space is required. The 16-bit samples are therefore mapped to 8-bit indices using a non-linear look up table.

At 350, the method 300 includes encoding the residual bytes of the compressed audio samples using runlength encoding (RLE). The RLE is similar, but not identical to, the one used for the image compression. The result of the silence detection and nonlinear mapping is that the RLE stage can produce a minimal quantity of data for each audio block.

The decoder (player) reverses the aforementioned process. Individual bytes and runs of identical bytes are expanded. Each 8 bit number is then applied to an inverse pre-computed lookup table to determine the 16 bit sample value for each audio sample position. The block of samples is then passed to audio output hardware. The process is double-buffered to avoid gaps in the audio.

The method can include determining a position of a cursor and other information on the computer screen at the predetermined time intervals. The mouse cursor and icon information is stored separately in Windows. Thus, on each audio and screen image check, the position of the mouse cursor is determined together with the cursor type. The cursor type is converted into an index into a list of standard Windows cursors. The output file stores the position and cursor type so that the decoder/player can resynthesise the cursor.

According to embodiments in which the images, audio and cursor information are recorded, the method includes synchronizing the computer screen images with the accompanying block of audio samples and with the accompanying position of the cursor and other information. According to some embodiments, in order to synchronize the audio track as closely as possible with the screen images, embodiments of the present invention use an audio sound card to capture blocks of audio samples. Once a block of audio samples is captured, the screen image is captured. The audio block size thus determines the relative synchronization of the audio with the video. According to some embodiments, the block size corresponds to approximately half a second.

It will be appreciated that a number of parameters must be chosen empirically. These are the number of colours to retain, the image sampling time, the audio sampling time, the image change threshold, image change delay, parameters in the mathematical equation for audio sample mapping, the audio silence threshold and optimal binary encoding for the byte or pixel run lengths. However, embodiments of the present invention are not limited to the particular values since a range of suitable values will exist for each parameter.

According to other embodiments, the method can include compressing the changed region using a JPEG image compression algorithm or one of its variants. Alternatively, other compression algorithms could be employed, such as using the fractal self-similarity of the image. Fractal compression is a known and accepted method whereby portions of an image are found to be self-similar. A portion of a given image can be restored simply by providing an offset and scaling factor.

Hence, embodiments of the present invention address or at least ameliorate one or more of the aforementioned problems of the prior art. Benefits of the present invention include the fact that any type of screen content may be captured. The present invention is not limited to specific programs or applications nor is it limited to any particular screen resolution and the audio is kept in synchronism with the screen image changes. Even at the end of an hour-long recording, according to some embodiments, the screen changes will be no more than 0.5 seconds delayed behind the audio. Data compression is used to significantly reduce the output file size, which is achieved without any user intervention. Nonetheless, good image and audio quality are maintained without s overburdening the processor such that the performance of other running applications is not impaired. Embodiments of the present invention perform a video buffer comparison and if a change in the images is detected an in-memory flag is set to indicate that an update is warranted. The flag can be set multiple times and can be checked at a lower rate than the rate at which the audio information is processed.

Throughout the specification the aim has been to describe the invention without limiting the invention to any one embodiment or specific collection of features. Persons skilled in the relevant art may realize variations from the specific embodiments that will nonetheless fall within the scope of the invention.

1. A method of capturing computer screen contents including:
capturing an image of the computer screen contents at predetermined time intervals;
capturing accompanying audio at the predetermined time intervals;
determining one or more changes between a current captured image and a previous captured image;
modifying color data associated with a changed region of the current captured image to reduce a color space for one or more pixels within the changed region; and
simultaneously encoding the modified color data for the changed region and the captured accompanying audio to synchronize the audio with the captured image.

2. The method of claim 1, including delaying further processing if the one or more changes between the current and previous captured images are greater than a predetermined threshold.

3. The method of claim 2, wherein the predetermined threshold is selected from the group consisting of: a percentage of the area of the screen and a number of pixels.

4. The method of claim 1, further including determining a frame containing pixels comprising the changed region.

5. The method of claim 1, wherein encoding the modified color colour data includes using runlength encoding.

6. The method of claim 1, further including updating the image of the computer screen by decoding the encoded modified color data for the changed region.

7. The method of claim 1, further including determining if an audio sample contains audible content when an energy level of the audio sample is equal to or greater than a predetermined level.

8. The method of claim 1, further including compressing the audio samples comprising audible content and simultaneously encoding the compressed audio samples with the modified color data for the changed region.

9. The method of claim 1, further including determining a position of a cursor on the computer screen at the predetermined time intervals.

10. The method of claim 9, further including synchronizing computer screen images with an accompanying position of a cursor.

11. An apparatus for capturing computer screen contents comprising:
computer readable program code components executed to cause capturing an image of the computer screen contents at predetermined time intervals;
computer readable program code components executed to cause capturing accompanying audio at the predetermined time intervals;
computer readable program code components executed to cause determining one or more changes between a current captured image and a previous captured image;
computer readable program code components executed to cause modifying color data associated with a changed region of the current captured image to reduce a color space for one or more pixels within the changed region; and
computer readable program code components executed to cause simultaneously encoding the modified color data for the changed region associated with the captured accompanying audio to synchronize the audio with the captured image.

12. The apparatus of claim 11, further including computer readable program code components executed to cause delaying further processing if the one or more changes between the current and previous captured images are greater than a predetermined threshold.

13. The apparatus of claim 12, wherein the predetermined threshold is selected from the group consisting of: a percentage of the area of the screen and a number of pixels.

14. The apparatus of claim 11, further including computer readable program code components executed to cause determining a frame containing pixels comprising the changed region.

15. The apparatus of claim 11, wherein encoding the modified color colour data includes using run length encoding.

16. The apparatus of claim 11, further including computer readable program code components executed to cause updating the image of the computer screen by decoding the encoded modified color data for the changed region.

17. The apparatus of claim 11, further including computer readable program code components executed to cause determining an audio sample contains audible content when an energy level of the audio sample is equal to or greater than a predetermined level.

18. The apparatus of claim 11, further including computer readable program code components executed to cause compressing the audio samples comprising audible content and simultaneously encoding the compressed audio samples with the modified color data of the changed region.

19. The apparatus of claim 11, further including computer readable program code components executed to cause determining a position of a cursor on the computer screen at the predetermined time intervals.

20. The apparatus of claim 19, further including computer readable program code components executed to cause synchronizing computer screen images with one or more of the following: an accompanying block of audio samples; and an accompanying position of a cursor.

21. An apparatus for capturing computer screen contents comprising:
a memory for storing images of the computer screen contents captured at predetermined time intervals;
a microphone operatively coupled to a processor for capturing accompanying audio at the predetermined time intervals;
a processor operatively coupled to the memory for:
determining one or more changes between a current captured image and a previous captured image;
modifying color data associated with a changed region of the current captured image to reduce a color space for one or more pixels within the changed region; and
simultaneously encoding the modified color data for the changed region and the captured accompanying audio to synchronize the audio with the captured image.

22. A machine readable medium having recorded thereon a program of instructions for causing a machine to perform a method of capturing computer screen contents, the method including:
capturing an image of the computer screen contents at predetermined time intervals;
capturing accompanying audio at the predetermined time intervals. determining one or more changes between a current captured image and a previous captured image;
modifying color data associated with a changed region of the 15 current captured image to reduce a color space for one or more pixels within the changed region; and
simultaneously encoding the modified color data for the changed region and the captured accompanying audio to synchronize the audio with the captured image.

23.-28. (canceled)
